(19) United States
(12) Patent Application Publication
(10) Pub. No.: US 2025/0136212 A1
(43) Pub. Date: May 1, 2025

(54) Articulating Bicycle Seat

(71) Applicant: Richard Anthony Almerico, Lutz, FL (US)

(72) Inventor: Richard Anthony Almerico, Lutz, FL (US)

(21) Appl. No.: 18/383,697

(22) Filed: Oct. 25, 2023

(51) Int. Cl. B62J 1/06; B62J 1/00; B62J 1/08

(52) U.S. Cl. CPC B62J 1/06; B62J 1/005; B62J 1/08

(57) ABSTRACT

An articulating seat that has a left articulating half seat with an upper rectangular left plate, a left plurality of parallel ribs, a left medial side edge element with a left aft rotation stop and a left forward rotation stop, and a left tubular element; and a right articulating half seat that has a upper rectangular right plate, a left plurality of parallel ribs, a right medial side edge element with a right aft rotation stop and a right forward rotation stop, and a right tubular element. The half seats have a mounting and a suspension that enables them to independently rotate on a plurality of bearings mounted on a transverse rod. Typically, rotation is about 25 degrees and rotate rearward is about 10 degrees. The plates are typically covered with cushions.

### BACKGROUND OF THE INVENTION

U.S. Pat. No. 5,823,618 to Harry M. and Joyce L Fox teaches a pedestal seat with two cushioned body halves, each having a helical spring and a leaf spring. Articulation is substantially limited to the compression of the helical spring, as the leaf springs have and upper clamp bar 25, which spans the two cushioned body halves The present invention relates to a seat for a pedaled apparatus, and more particularly to an articulating seat that has a suspension system with a partial adjustable level of stiffness, wherein the articulating seat has two cushions that are independently articulating and generally provide a larger surface area of cushioning.

### BRIEF STATEMENT OF THE INVENTION

The present invention relates to a seat for a pedaled apparatus, and more particularly to an articulating seat that has a suspension system with a partial adjustable level of stiffness, wherein the articulating seat has two cushions that are independently articulating and generally provide a larger surface area of cushioning.

### SUMMARY OF THE INVENTION

The present invention is an articulating seat that has a suspension system with an adjustable level of stiffness, wherein the articulating seat has two cushions that are independently articulating and generally provide a larger surface area of cushioning, without any obstruction to pedaling).

### OBJECT AND SUMMARY OF THE INVENTION

A first object of the invention is to enable proper pelvic and sacroiliac movement while peddling to reduce chance of injury.

A second object of the invention is to enable proper distribution of weight along the sacro tubercles to reduce pain while sitting.

A third object of the invention is to enable proper motion of a rider's hips and sacroiliac joints during peddling to reduce chance of muscle strain.

A fourth object of the invention is to promote better lumbar spine posture while riding to reduce incidence of lower back pain.

A fifth object of the invention is to provide an suspension system for both of the articulating cushions, and

A sixth object of the invention is to provide a suspension system with an adjustable level of stiffness.

These and other objects and advantages of the present invention will be readily appreciable from the following description of preferred embodiments of the invention and from the accompanying drawings and claims.

### FIELD AND BACKGROUND OF THE INVENTION

a U.S. Pat. No. 6,402,235 to Rodger B. Letendre teaches split bicycle seat that comprises: a seat mount; and two split seat halves having a transverse rotational axis, each half mounted to the seat mount so that the seat halves are capable of rotating at least partially about the transverse axis. There is no teaching of a suspension, only that the cushions can be horseshoe shaped and that some articulation can occur with “the split seat halves are capable of rotating from side to side about a longitudinal axis, wherein the pillow block joints are fixed to the transverse rod so that the split seat halves are capable of rotating to each side about 10°

### FIELD OF THE INVENTION

U.S. Pat. No. 7,494,181 to Samuel Tucker teaches a preferred apparatus wherein the first and second seat portions can independently pivot in a horizontal axis normal to a frame plane of the bicycle, and also articulate. The seat portions are preferably configured to jointly support the rider and to provide a gap for the rider's groin. The seat portions are preferably secured to the bicycle frame in a manner that allows adjustable lateral rotation in relation to the bicycle frame, further facilitating the rider's freedom of movement during pedaling. There is no teaching of a suspension system. In one embodiment shock absorbers 1902 are used to restrict pivoting in the horizontal axis. Advantageously, shock absorbers would provide some restraint against torsional twisting action, which could be harmful to a rider

### BRIEF DESCRIPTION OF DRAWINGS

The foregoing invention will become readily apparent by referring to the following descriptions and the appended drawings in which:

FIG. 1 is an angled left side perspective view of the articulating seat fitted with cushions, wherein a right aft rotation stop of a right medial side edge element is in abutment with a downward extending vertical right section that is welded to a bottom edge of a transverse metal rod;

FIG. 2 is an exploded frontal view of the right side of the articulating seat, wherein the left side is assembled;

FIG. 3 is an angled right side perspective view of the articulating seat without cushions;

FIG. 4 is a perspective view of the inventive elements largely composed of metal;

FIG. 5 is a cross-sectional end on view of the articulating seat along sectional line 5-5 shown in FIG. 2;

FIG. 6 is an overhead angled perspective partial view of the invented transverse axle fitted with an individual interfacing suspension having metallic forward extending right and left loop elements, where the loop elements are mounted to a post with a universal mount having a pair of clamps and a band; and

FIG. 7 is a perspective view of the invented articulating seat fitted with cushions and mounted on a bicycle, wherein the bicycle is not a limiting part of the invention.

### DESCRIPTION OF THE INVENTION

At least one specification heading is required. Please delete this heading section if it is not applicable to your application. For more information regarding the headings of the specification, please see MPEP 608.01(a). Illustrative embodiments and exemplary applications will be described with reference to the accompanying drawings to disclose the advantageous teachings of the present invention.

Various embodiments of the invention are described more fully hereinafter with reference to the accompanying drawings, in which some, but not all of the embodiments of the invention are shown in the figures. Indeed, these inventions may be embodied in many different forms and should not be construed as limited to the embodiments set forth herein; rather, these embodiments are provided so that this disclosure will satisfy applicable legal requirements. Those having ordinary skill in the art and access to the teachings provided herein will recognize addition.

The invented apparatus allows for proper pelvic and sacroiliac movement while peddling to reduce chance of injury, in part because peddling can easily be done while still sitting, as a half seat easily pivots as a rider's leg moves downward.

The invented apparatus allows for proper distribution of weight along the sacro tubercles to reduce pain while sitting. The coccyx connects with the sacrum through the sacrococcygeal joint, and there is normally limited movement between the coccyx and the sacrum. The coccyx usually moves slightly forward or backward as the pelvis, hips, and legs move. When a person sits or stands, the bones that make up the pelvis (including the coccyx) rotate outward and inward slightly to better support and balance the body. Articulation of the cushions permits outward rotation, and the cushions themselves distort accommodating inward movement.

The invented apparatus allows for proper motion of your hips and sacroiliac joints during peddling, reducing the chance of muscle strain. In general, more power can be generated while still sitting, as the seat pivots downward about 20 degrees out of the way, allowing the thigh muscles to do more work without actually standing.

The invented apparatus promotes better lumbar spine posture during ride to reduce incidence of lower back pain while riding. The invention reduces the need to bend the lower back, therein imparting better posture and less lower back pain.

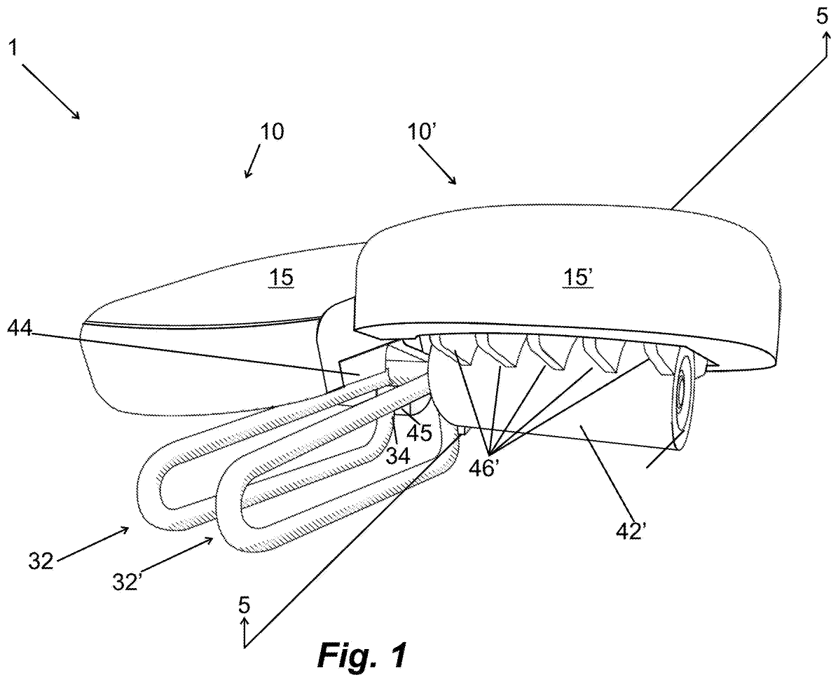

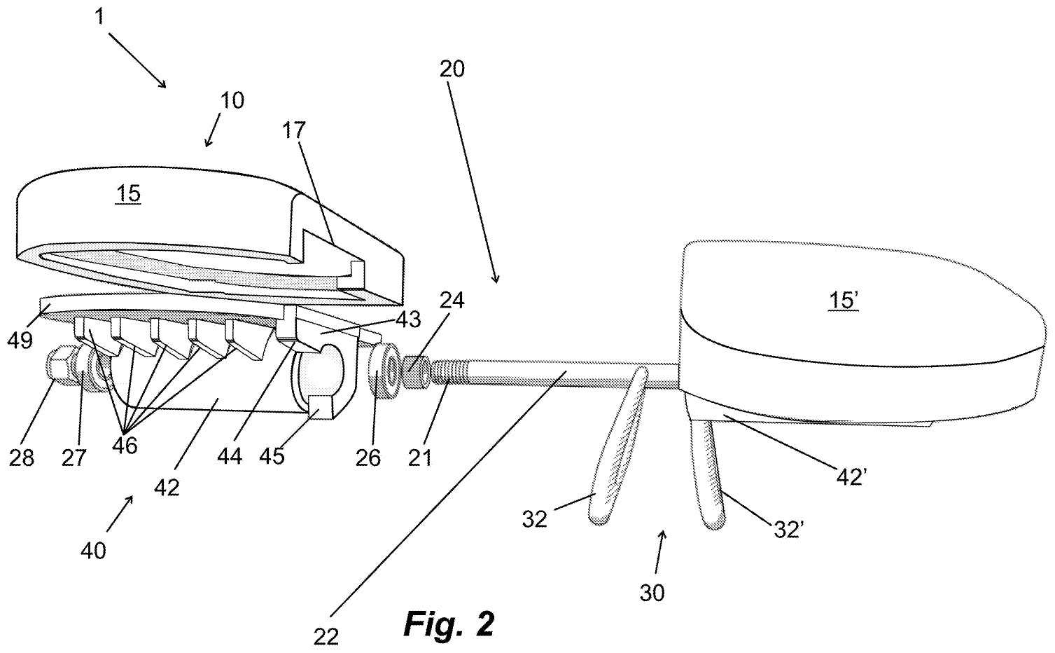

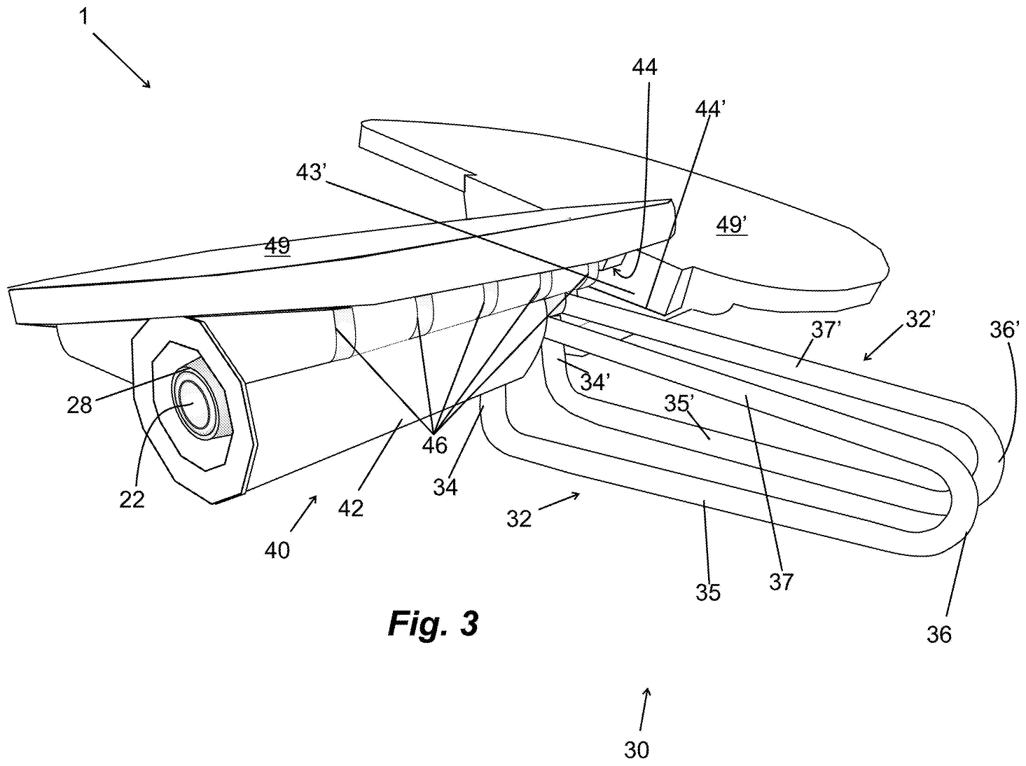

As illustrated in FIG. 1, the articulating seat 1 has a left half 10′ and a right half 10, that are substantially mirror images. Visible in FIG. 1 is a left half articulating plate fitted with a left cushion 15′, and a right half articulating plate fitted with a right cushion 15. The cushions 15 and 15′ are covering an upper rectangular right plate 49, as shown in FIG. 3, and an upper rectangular left plate 49′ shown in FIG. 3. As illustrated in FIGS. 2 and 3, the right plate 49 is reinforced with a right plurality of parallel ribs 46. Similarly, a plurality of parallel ribs 46′ is shown in FIG. 1. The plurality of parallel ribs 46,46′ are coextensive with tubular element 42,42′.

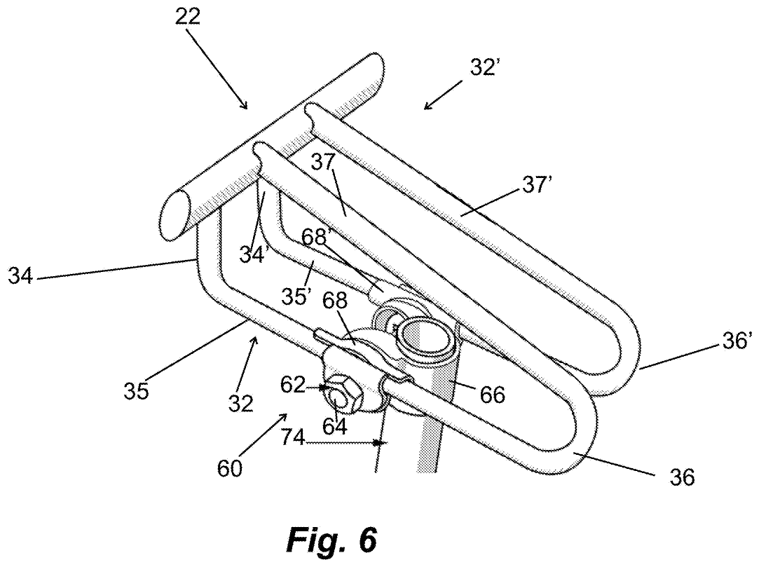

FIG. 2 is an exploded frontal view of the right side of the articulating seat 1. The invented articulating half seats have independent and limited articulation. The articulating seat 1 includes a shared transverse metal rod 22 having a length that can accommodate both the left half articulating plate 15′ and the right half articulating plate 15. The transverse metal rod 22 is centered with respect to a seat post 74, as shown in FIG. 6, which defines a center line for a bicycle 70. The transverse metal rod 22 is orthogonal to the center line. The transverse metal rod has a pair 30 of loop elements 32,32′ that are substantially mirror images of each other.

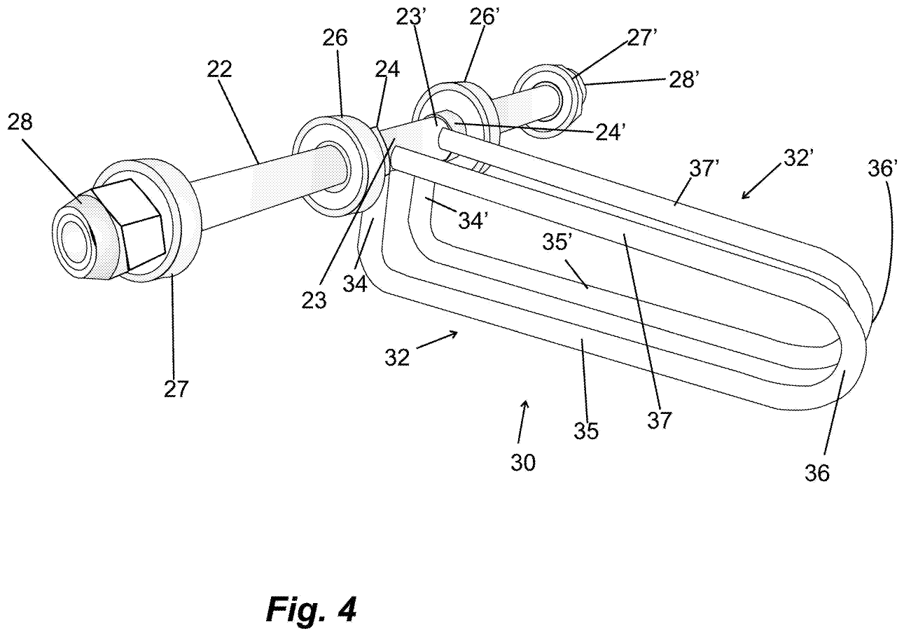

As shown in FIG. 4, a medial left side 23′ of the transverse metal rod 22 has a metallic forward extending left loop element 32′, and a medial right side 23 of the transverse metal rod 22 has a metallic forward extending right loop element 32. Each of the loop elements 32,32′ include an upper forward extending section 37,37′ from the transverse metal rod 22 and a downward extending vertical section 34,34′ from a bottom of the transverse metal rod 22. Each of the downward extending vertical sections 34,34′ curves forward, therein becoming lower forward extending sections 35,35′ that are substantially parallel to the upper forward extending sections 37,37′. The upper forward extending sections 37,37′ and the lower forward extending sections 35,35′ curve therein forming contiguous “U” shaped elements 36,36′ of loop elements 32,32′. The loop element 32 right side 23 of the transverse metal rod 22 and the loop element 32′ on the medial left side 23′of the transverse metal rod 22.

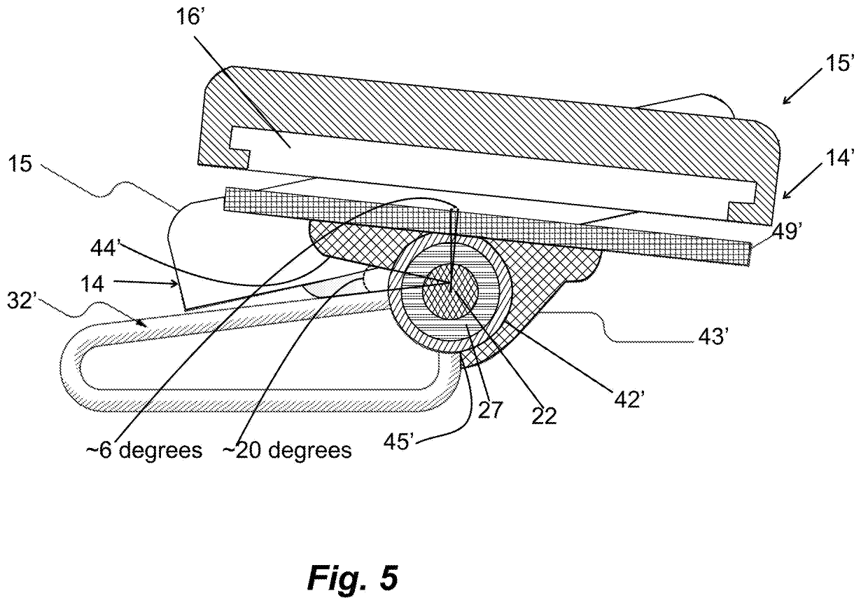

Typically, as shown in FIG. 5, each half seat 10,10′ can rotate forward about 20 degrees from a level position until the forward rotation stop 44,44′ comes into contact with the upper forward extending sections 37,37′, and each half seat 10,10′ can rotate backwards from the level position at least about 6 degrees until the aft rotation stop 45,45′ comes into contact with vertical sections 34,34′. It is anticipated that each half seat 10,10′ could rotate forward about 35 degrees from a level position and each half seat 10,10′ could rotate backwards from the level position at least about 15 degrees until the aft rotation stop.

Referring to FIG. 3, the right half seat 10 includes upper rectangular right plate 49, the left half seat 10′ includes the upper rectangular left plate 49′, a right plurality of parallel ribs 46, a left medial side edge element 43′ with a right aft rotation stop 45 (see FIG. 1) and a right forward rotation stop 44, and a right tubular element 42. Each half seat 10,10′ can be molded into one contiguous piece made of an engineering plastic selected from the group consisting of: ABS, Nylon®, polycarbonate, poly-acrylate, epoxy resin, melamine, foramide, fiberglass, acetal, delrin®, glass reinforced polyester, glass reinforced polypropylene, polyimide, and combinations thereof.

The upper rectangular right plate 49 can be covered with a right cushion 15, and upper rectangular left plate 49′ can be covered with a left cushion 15′.

Similarly, the left articulating half seat 10′ includes the upper rectangular left plate 49′, the left plurality of parallel ribs 46′, a left medial side edge element 43′ with a left aft rotation stop 45′ and a left forward rotation stop 44′, and a left tubular element 42′ can be molded into one contiguous piece of an engineering plastic.

The upper rectangular left plate is covered with a left cushion 15′. As shown in FIG. 5 cushion 15′ has lipped side walls 14′, therein forming a chamber which can receive upper rectangular right plate 49′. Likewise cushion 15 has lipped side walls 14, therein forming a chamber which can receive the upper rectangular right plate 49.

Also shown in FIG. 1 is that an end of the transverse rod 22 is threaded 21. The other end is also threaded and both threaded ends are capped with a lock nut 28,28′ as shown in FIG. 4. The medial right side 23 of the transverse metal rod 22 has a right sleeve 24, a right inboard bearing 26, a right outboard bearing 27 and the right locknut 28. The medial left side 23′ of the transverse metal rod 22 has a left sleeve 24′, a left inboard bearing 26′, a left outboard bearing 27′ and the left locknut 28′.

The transverse metal rod 22 obviously cannot rotate, as the loop elements 32,32′ are contiguous with the transverse metal rod 22, and as shown in FIG. 6 are clamped to a post 74. transverse metal rod and the elements 32,32′ are typically made of a steel, and preferably a grade of stainless steel.

A partial view of the invented transverse metal rod 22 fitted with metallic forward extending right and left loop elements is shown in FIG. 6. The loop elements lower sections 35,35′ are mounted to the bicycle's post 74 with a universal mount 60. The universal mount 60 has a pair of clamps 68,68′ which are clamping the loop elements lower sections 35,35′ about midway, and a band 66 is secured to the post 74. A clamp bolt 64 and a clamp nut 62 simultaneously tighten the band 66 and the clamps 68,68′.

Note, as the transverse metal rod 22 is moved closer to the post 74, the articulating seat 1 moves forward. Alternatively, as the transverse metal rod 22 is moved away from the post 74, the articulating seat 1 moves rearwards. At the articulating seat's 1 most rearward position there will be more flex in the clamped loop elements lower sections 35,35′, therein providing a slightly softer suspension, without affecting articulation. Furthermore, the clamp can be moved downward on post 74, therein lowering the invented articulating seat 1.

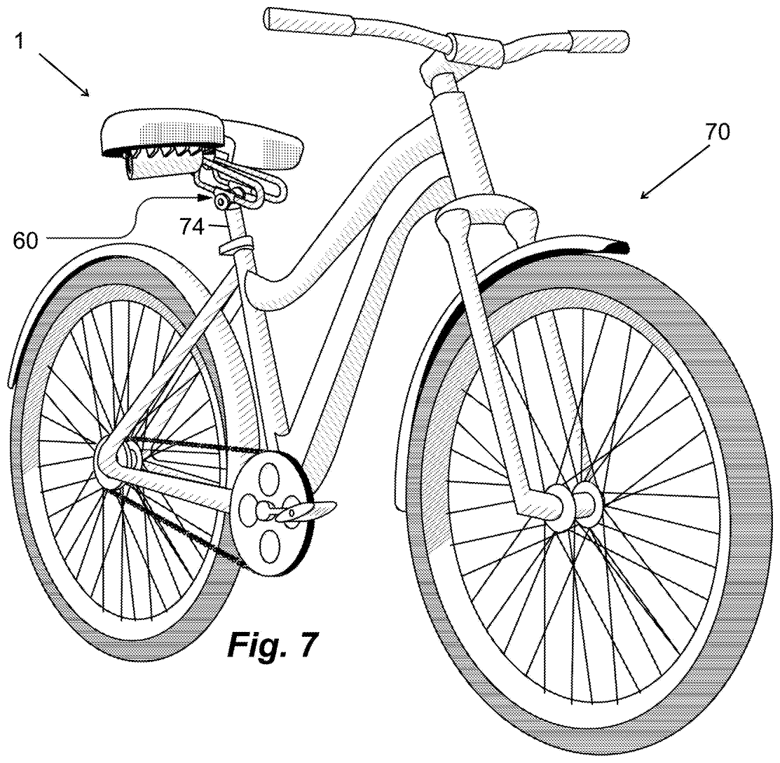

In FIG. 7 the invented articulating seat 1 is on a bicycle 70. The articulating seat 1 is fitted with cushions, and it is mounted at an upper position on post 74 using the universal mount 60.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

Finally, any numerical parameters set forth in the specification and attached claims are approximations (for example, by using the term “about”) that may vary depending upon the desired properties sought to be obtained by the present invention. At the very least, and not as an attempt to limit the application of the doctrine of equivalents to the scope of the claims, each numerical parameter should at least be construed in light of the number of significant digits and by applying ordinary rounding.

What is claimed is:

1. An articulating seat, said articulating seat comprising:
a left articulating half seat comprising: an upper rectangular left plate, a left plurality of parallel ribs 46′, a left medial side edge element with a left aft rotation stop and a left forward rotation stop, and a left tubular element;
a right articulating half seat comprising: an upper rectangular right plate, a left plurality of parallel ribs, a right medial side edge element with a right aft rotation stop and a right forward rotation stop, and a right tubular element;
a mounting and suspension means comprising a transverse metal rod having a right threaded end and a left threaded end, said transverse metal rod having a medial right side with a right sleeve, a right inboard bearing, a right outboard bearing, said right threaded end capped with a right locknut, and having a medial left side with a left sleeve, a left inboard bearing, a left outboard bearing said left threaded end capped with a left locknut; and projecting forward from the medial right side and the medial left side of the transverse metal rod is a pair loop elements comprising a right upper forward extending section, a left upper forward extending section, and from a bottom of the transverse metal rod is a right downward extending vertical section which curves forward forming a right lower forward extending section, and also from the bottom of the transverse metal rod a left downward extending vertical section which curves forward forming a left lower forward extending section, said right upper forward extending section and said right lower forward extending section meeting therein forming a contiguous “U” shaped right loop element; and said left upper forward extending section and said left lower forward extending section meeting therein forming a contiguous “U” shaped left loop element, wherein the left loop element is on the medial left side of the transverse metal rod and the right loop element is on the medial right side of the transverse metal rod.

2. The articulating seat according to claim 1, wherein said left lower forward extending section and said right lower forward extending section of the loop elements are clamped with a universal mount with a pair of clamps, and mounted to a bicycle's post utilizing a band around the bicycle's post.

3. The articulating seat according to claim 1, wherein said upper rectangular left plate is fitted with a left cushion, and said upper rectangular right plate is fitted with a right cushion.

4. The articulating seat according to claim 1, wherein said right plurality of parallel ribs are coextensive with said right tubular element and said upper rectangular right plate.

5. The articulating seat according to claim 1, wherein said left plurality of parallel ribs is coextensive with said left tubular element and said upper rectangular left plate.
